(19) United States
(12) Patent Application Publication
(10) Pub. No.: US 2025/0083632 A1
(43) Pub. Date: Mar. 13, 2025

(54) FRONT STRUCTURE OF VEHICLE

(71) Applicant: Honda Motor Co., Ltd., Tokyo (JP)

(72) Inventors: Takeshi SASAKI, Tokyo (JP); Shuhei KUWAHATA, Tokyo (JP); Shota ANEGAWA, Tokyo (JP)

(73) Assignee: Honda Motor Co., Ltd., Tokyo (JP)

(21) Appl. No.: 18/761,265

(22) Filed: Jul. 1, 2024

(30) Foreign Application Priority Data
Sep. 11, 2023 (CN) 202311161888.2

(51) Int. Cl. B60R 21/36; B60S 1/18

(52) U.S. Cl. CPC B60R 21/36; B60S 1/18

(57) ABSTRACT

A front structure of a vehicle includes a front vehicle component and a wiper device installed on the front vehicle component. The wiper device includes a first supporting component and a second supporting component. The first supporting component rotatably supports a first wiper component and is installed at a first position in the front vehicle component close to a driver's seat side. The second supporting component is spaced apart from the first supporting component, rotatably supports a second wiper component, and is installed at a second position in the front vehicle component closer to a center side than the first position in a vehicle width direction. The front structure of the vehicle further includes a driver's seat side pedestrian airbag installed between the first position and the second position in the front vehicle component.

### CROSS-REFERENCE TO RELATED APPLICATION

This application claims the priority benefit of China application no. 202311161888.2, filed on Sep. 11, 2023. The entirety of the above-mentioned patent application is hereby incorporated by reference herein and made a part of this specification.

### BACKGROUND

### Technical Field

The disclosure relates to a front structure of a vehicle.

### Description of Related Art

In order to allow disadvantaged groups such as the elderly, the disabled, and children to be able to use sustainable transportation systems as well, efforts are made on research and development of preventive safety technologies with an aim to provide improved traffic safety and convenience. In the related art, a wiper device is installed on the front structure of a vehicle. However, the mechanism of the wiper device occupies the surrounding space, so that other components cannot be installed around the wiper device, especially airbags for pedestrian protection. In order to solve the abovementioned problems, the disclosure aims to improve the space utilization efficiency in the front structure of the vehicle, so that preventive safety technologies in transportation can be further improved and the sustainable transportation systems can be further developed.

### SUMMARY

The disclosure provides a front structure of a vehicle capable of improving space utilization and traffic safety.

The disclosure provides a front structure of a vehicle including a front vehicle component and a wiper device installed on the front vehicle component. The wiper device includes a first supporting component and a second supporting component. The first supporting component rotatably supports a first wiper component and is installed at a first position in the front vehicle component close to a driver's seat side. The second supporting component is spaced apart from the first supporting component, rotatably supports a second wiper component, and is installed at a second position in the front vehicle component closer to a center side than the first position in a vehicle width direction. Herein, the front structure of the vehicle further includes a driver's seat side pedestrian airbag installed between the first position and the second position in the front vehicle component.

To make the aforementioned more comprehensible, several embodiments accompanied with drawings are described in detail as follows.

### BRIEF DESCRIPTION OF THE DRAWINGS

FIG. 1 is a schematic top view of a front structure of a vehicle according to an embodiment of the disclosure.

FIG. 2 is a schematic view of FIG. 1 with a wiper component and an airbag cover hidden.

FIG. 3A to FIG. 3C are partial enlarged schematic views of regions A to C in FIG. 1 respectively.

FIG. 4 is a schematic perspective view of a wiper device of the front structure of the vehicle according to this embodiment.

FIG. 5 is a schematic perspective view of a wiper device of the front structure of the vehicle according a variation example.

### DESCRIPTION OF THE EMBODIMENTS

The disclosure provides a front structure of a vehicle capable of improving space utilization and traffic safety.

The disclosure provides a front structure of a vehicle including a front vehicle component and a wiper device installed on the front vehicle component. The wiper device includes a first supporting component and a second supporting component. The first supporting component rotatably supports a first wiper component and is installed at a first position in the front vehicle component close to a driver's seat side. The second supporting component is spaced apart from the first supporting component, rotatably supports a second wiper component, and is installed at a second position in the front vehicle component closer to a center side than the first position in a vehicle width direction. Herein, the front structure of the vehicle further includes a driver's seat side pedestrian airbag installed between the first position and the second position in the front vehicle component.

In an embodiment of the disclosure, the wiper device further includes a connecting rod connecting the first wiper component and the second wiper component so that the two move synchronously. The connecting rod and the driver's seat side pedestrian airbag are arranged side by side in a vehicle front-rear direction.

In an embodiment of the disclosure, the front structure of the vehicle further includes a passenger's seat side pedestrian airbag and a connecting component. The passenger's seat side pedestrian airbag is installed at a position in the front vehicle component closer to a passenger's seat side than the second position in the vehicle width direction. The connecting component connects the driver's seat side pedestrian airbag and the passenger's seat side pedestrian airbag. The connecting component and the second wiper component are arranged side by side in the vehicle front-rear direction.

To sum up, in the front structure of the vehicle provided by the disclosure, the first supporting component and the second supporting component configured to support the wiper component are provided on the front vehicle component in a non-connected manner. As such, the space between the first position and the second position is utilized and can be used for installation of the driver's seat side pedestrian airbag or other components. The efficiency of space usage is thereby improved, and the safety of pedestrians is also protected. Accordingly, the front structure of the vehicle provided by the disclosure can improve space utilization and traffic safety.

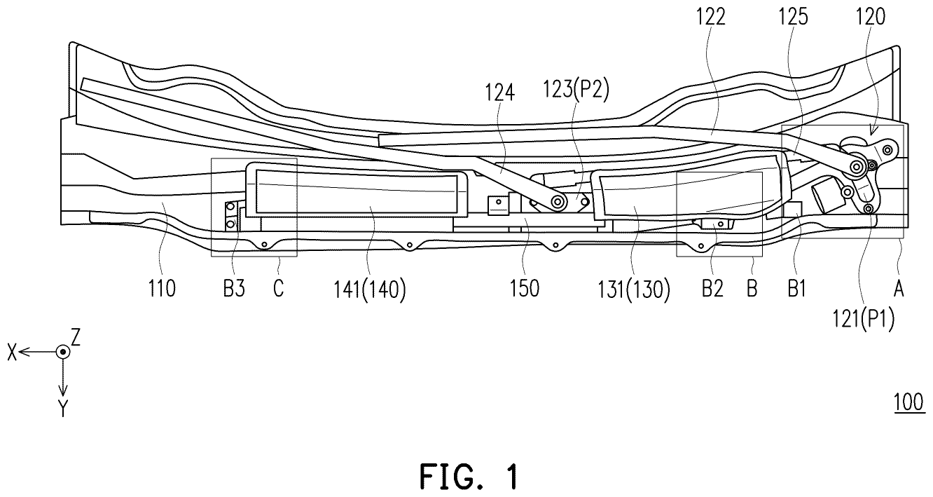

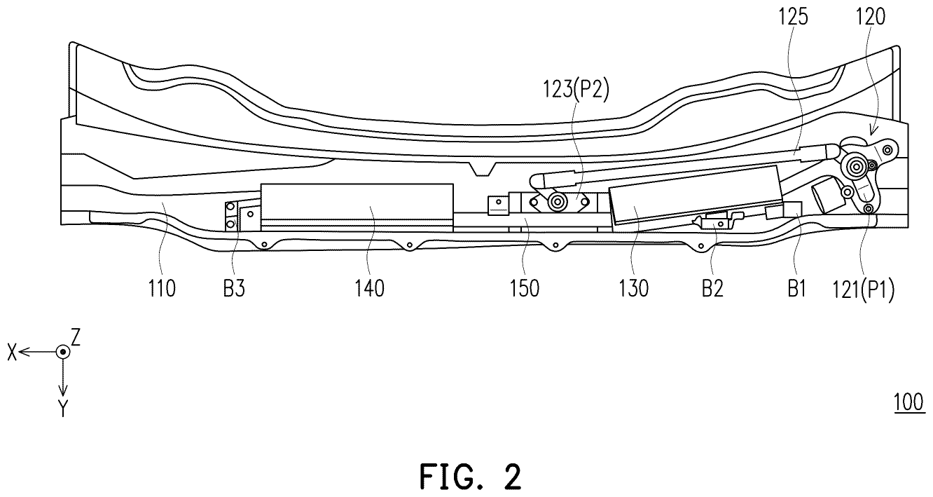

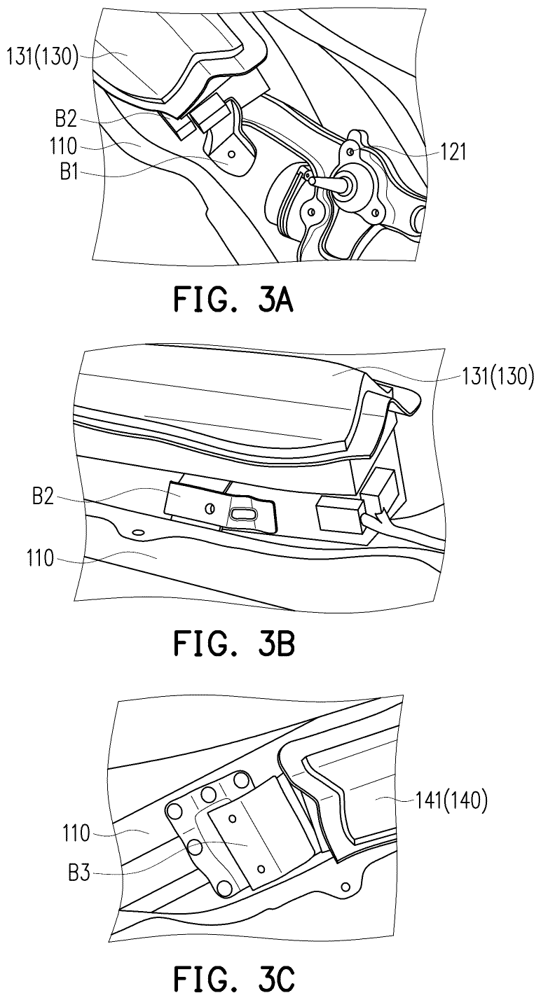

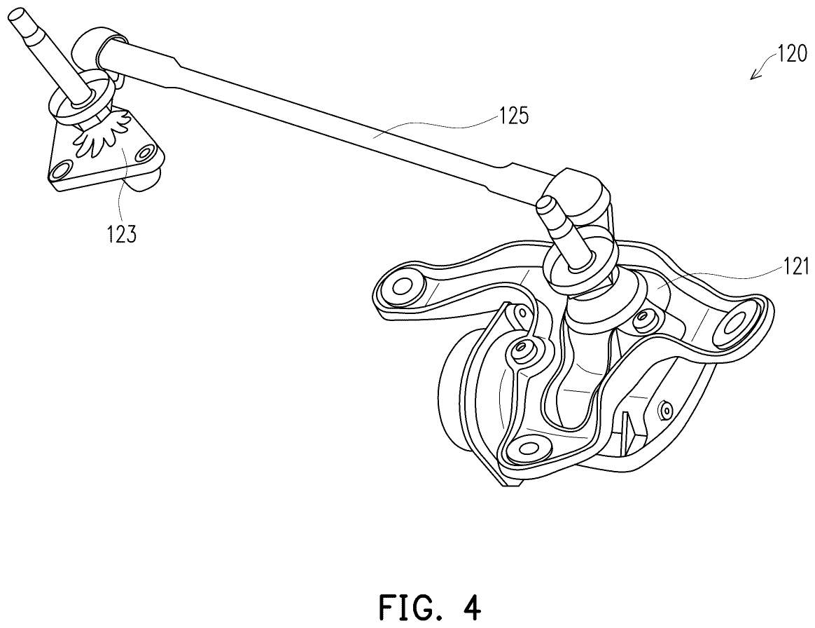

FIG. 1 is a schematic top view of a front structure of a vehicle according to an embodiment of the disclosure. FIG. 2 is a schematic view of FIG. 1 with a wiper component and an airbag cover hidden. FIG. 3A to FIG. 3C are partial enlarged schematic views of regions A to C in FIG. 1 respectively. FIG. 4 is a schematic perspective view of a wiper device of the front structure of the vehicle according to this embodiment. In this embodiment, a front structure 100 of a vehicle is, for example, the front structure of an ordinary passenger car (not shown), but the disclosure is not limited thereto, and the front structure 100 may also be applied to other suitable vehicles. A vehicle width direction X, a vehicle front-rear direction Y, and a vehicle up-down direction Z in the drawings are not intended to limit the positional relationship of the components in the disclosure. Further, it shall be noted that, unless otherwise specified, front and upper directions used in the following paragraphs of the specification are the directions pointed by arrows in the vehicle front-rear direction Y and the vehicle up-down direction Z. Rear and downward directions used in the specification are the opposite directions to the above. A left direction in the specification is the direction pointed by the arrow in the vehicle width direction X, not the actual left direction of the vehicle. A right direction in the specification is the opposite direction to the above. Besides, a driver's seat side and a passenger's seat side in the specification are assumed to be left-hand drive, but are not used to limit the positions in the disclosure. Wherever possible, the same reference numbers are used in the drawings and the description to refer to the same or like parts. A structure of the front structure 100 of the vehicle of this embodiment is described in the following paragraphs with reference to FIG. 1 and FIG. 4.

With reference to FIG. 1, in this embodiment, the front structure 100 of the vehicle includes a front vehicle component 110, a wiper device 120, and a driver's seat side pedestrian airbag 130. The front vehicle component 110 is, for example, a dash board cover, and the wiper device 120 is installed on the front vehicle component 110 to remove water from a front window (now shown) of the vehicle, but the disclosure is not limited thereto. The wiper device 120 includes a first supporting component 121 and a second supporting component 123. The first supporting component 121 rotatably supports a first wiper component 122, that is, the first wiper component 122 rotates with the first supporting component 121 as an axis. Further, the first supporting component 121 is installed at a first position P1 close to the driver's seat side of the front vehicle component 110 (right side in the vehicle width direction X). The second supporting component 123 is spaced apart from the first supporting component 121, that is, the two are not connected, but the disclosure is not limited thereto. The second supporting component 123 rotatably supports a second wiper component 124, that is, the second wiper component 124 rotates with the second supporting component 122 as an axis. Further, the second supporting component 123 is installed at a second position P2 in the front vehicle component 110 closer to a center side than the first position P1 in the vehicle width direction X (relatively closer to the passenger's seat side). Besides, the driver's seat side pedestrian airbag 130 is installed between the first position P1 and the second position P2 in the front vehicle component 110.

It thus can be seen that in the front structure 100 of the vehicle provided by this embodiment, the first supporting component 121 and the second supporting component 123 configured to support the wiper component 120 are provided on the front vehicle component 110 in a non-connected manner. As such, a space between the first position P1 and the second position P2 is utilized and can be used for installation of the driver's seat side pedestrian airbag 130 or other components. The efficiency of space usage is thereby improved, and the safety of pedestrians may also be protected. Accordingly, the front structure 100 of the vehicle of this embodiment can improve space utilization and traffic safety.

With reference to FIG. 1, FIG. 2, and FIG. 4, further, in this embodiment, the wiper device 120 further includes a connecting rod 125. The connecting rod 125 connects the first wiper component 122 and the second wiper component 124, so that the two move synchronously. That is, it is only necessary to drive one of the first wiper component 122 and the second wiper component 124 to make both move together. Since there is a space between the first supporting component 121 and the second supporting component 123 so that the driver's seat side pedestrian airbag 130 can be arranged, the connecting rod 125 and the driver's seat side pedestrian airbag 130 may be arranged side by side in the vehicle front-rear direction Y (as shown in FIG. 2). Further, the driver's seat side pedestrian airbag 130 is provided with a driver's seat side pedestrian airbag cover 131, and the driver's seat side pedestrian airbag cover 131 is formed to be larger. Therefore, in addition to covering an airbag body, the driver's seat side pedestrian airbag cover 131 may also cover the connecting rod 125 to protect the connecting rod 125 from being impacted. In other embodiments that are not shown, the driver's seat side pedestrian airbag cover 131 may also be formed smaller depending on actual needs, which is not limited by the disclosure.

Besides, in this embodiment, the front structure 100 of the vehicle further includes a passenger's seat side pedestrian airbag 140 and a connecting component 150. The passenger's seat side pedestrian airbag is installed at a position in the front vehicle component 110 closer to the passenger's seat side than the second position P2 in the vehicle width direction X, that is, closer to the left side in the vehicle width direction X. The connecting component 150 connects the driver's seat side pedestrian airbag 130 and the passenger's seat side pedestrian airbag 140. Herein, the connecting component 150 and the second wiper component 124 are arranged side by side in the vehicle front-rear direction Y. In this way, the arrangement of the front structure 100 of the vehicle may be made compact. The space utilization is thereby improved, and the safety of pedestrians near the passenger's seat side may be further protected.

Further, in this embodiment, the passenger's seat side pedestrian airbag 140 is provided with a passenger's seat side pedestrian airbag cover 141, and the passenger's seat side pedestrian airbag cover 141 is formed to be larger to cover the airbag body, which is not limited by the disclosure, however. The connecting component 150 is arranged at a position lower than the driver's seat side pedestrian airbag cover 131 and the passenger's seat side pedestrian airbag cover 141 in the vehicle up-down direction Z.

With reference to FIG. 3A to FIG. 3C, in this embodiment, the driver's seat side pedestrian airbag 130 and the passenger's seat side pedestrian airbag 140 are fixed to the front vehicle component 110 through, for example, a bracket B1, a bracket, B2, and a bracket B3. Taking the driver's seat side pedestrian airbag 130 as an example, it is fixed onto the right side in the vehicle width direction X by the bracket B1 and onto the front side in the vehicle front-rear direction Y by the bracket B2. The passenger's seat side pedestrian airbag 140 is fixed onto the left side in the vehicle width direction X by the bracket B3. Further, fasteners such as bolts may also be used to pass through the bracket B1, the bracket B2, and the bracket B3 to fix the driver's seat side pedestrian airbag 130 and the passenger's seat side pedestrian airbag 140 onto the front vehicle component 110, but the disclosure is not limited thereto.

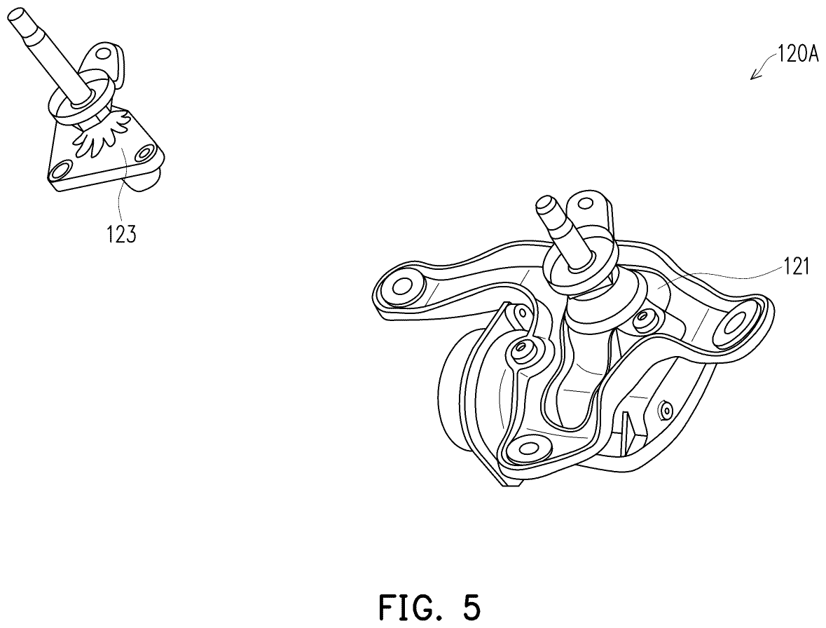

FIG. 5 is a schematic perspective view of a wiper device of the front structure of the vehicle according a variation example. With reference to FIG. 5, in a variation example, the difference between a wiper device 120A and the wiper device 120 is that the connecting rod 125 is not provided. Therefore, in the case of the wiper device 120A, a driving unit (not shown) is provided on each of the first supporting component 121 and the second supporting component 123 to drive the first wiper component 122 and the second wiper component 124 respectively. In this way, more space is provided between the first supporting component 121 and the second supporting component 123 for installation of other components, and that the space utilization and degree of freedom are improved.

In view of the foregoing, in the front structure of the vehicle provided by the disclosure, the first supporting component and the second supporting component configured to support the wiper component are provided on the front vehicle component in a non-connected manner. As such, the space between the first position and the second position is utilized and can be used for installation of the driver's seat side pedestrian airbag or other components. The efficiency of space usage is thereby improved, and the safety of pedestrians may also be protected. Further, the passenger's seat side pedestrian airbag may also be arranged, and the free space is used for installation of the connecting component that connects the driver's seat side pedestrian airbag and the passenger's seat side pedestrian airbag. Accordingly, the front structure of the vehicle provided by the disclosure can improve space utilization and traffic safety.

Finally, it is worth noting that the foregoing embodiments are merely described to illustrate the technical means of the disclosure and should not be construed as limitations of the disclosure. Even though the foregoing embodiments are referenced to provide detailed description of the disclosure, people having ordinary skill in the art should understand that various modifications and variations can be made to the technical means in the disclosed embodiments, or equivalent replacements may be made for part or all of the technical features; nevertheless, it is intended that the modifications, variations, and replacements shall not make the nature of the technical means to depart from the scope of the technical means of the embodiments of the disclosure.

What is claimed is:

1. A front structure of a vehicle comprising a front vehicle component and a wiper device installed on the front vehicle component, wherein the wiper device comprises:
a first supporting component rotatably supporting a first wiper component and installed at a first position in the front vehicle component close to a driver's seat side; and
a second supporting component spaced apart from the first supporting component, rotatably supporting a second wiper component, and installed at a second position in the front vehicle component closer to a center side than the first position in a vehicle width direction, wherein
the front structure of the vehicle further comprises a driver's seat side pedestrian airbag installed between the first position and the second position in the front vehicle component.

2. The front structure of the vehicle according to claim 1, wherein
the wiper device further comprises a connecting rod connecting the first wiper component and the second wiper component so that the two move synchronously, and
the connecting rod and the driver's seat side pedestrian airbag are arranged side by side in a vehicle front-rear direction.

3. The front structure of the vehicle according to claim 1, further comprising:
a passenger's seat side pedestrian airbag installed at a position in the front vehicle component closer to a passenger's seat side than the second position in the vehicle width direction; and
a connecting component connecting the driver's seat side pedestrian airbag and the passenger's seat side pedestrian airbag, wherein the connecting component and the second wiper component are arranged side by side in a vehicle front-rear direction.

4. The front structure of the vehicle according to claim 2, further comprising:
a passenger's seat side pedestrian airbag installed at a position in the front vehicle component closer to a passenger's seat side than the second position in the vehicle width direction; and
a connecting component connecting the driver's seat side pedestrian airbag and the passenger's seat side pedestrian airbag, wherein the connecting component and the second wiper component are arranged side by side in the vehicle front-rear direction.
